(19) United States
(12) Patent Application Publication
(10) Pub. No.: US 2012/0245315 A1
(43) Pub. Date: Sep. 27, 2012

(54) PROCESS FOR THE POLYMERIZATION OF STYRENE

(75) Inventors: Andreas Herman Hogt, Enschede (NL); Bart Fischer, Leusden (NL)

(73) Assignee: AKZO NOBEL CHEMICALS INTERNATIONAL B.V., Amersfoort (NL)

(21) Appl. No.: 13/513,681

(22) PCT Filed: Dec. 7, 2010
(86) PCT No.: PCT/EP2010/069012

§ 371 Date: Jun. 4, 2012

Related U.S. Application Data
(60) Provisional application No. 61/285,316, filed on Dec. 10, 2009.

(30) Foreign Application Priority Data
Dec. 10, 2009 (EP) 09178690.5

(51) Int. Cl. C08F 2/44

(52) U.S. Cl. 526/206

(57) ABSTRACT

A process for the suspension polymerization of styrene monomer to produce polystyrene comprising the steps of (a) heating a polymerization suspension comprising the styrene monomer to a temperature of at least 60° C., (b) dosing an initiator to said heated polymerization suspension during the polymerization reaction over a period of more than 90 minutes to less than 5 hours, in a continuous manner or intermittently in at least 2 portions, said period starting at a monomer conversion of 65% of less and said initiator having a half-life at the temperature at which it is dosed of not more than 60 minutes, wherein a brominated flame retardant is present in the polymerization suspension during the polymerization reaction.

The invention relates to a process for the polymerization of styrene monomer in the presence of a brominated flame retardant for the production of polystyrene, in particular expandable polystyrene (EPS).

It is known to produce expandable polystyrene by suspension polymerization of styrene with addition of blowing agents. This process results in the formation of polymer beads. Examples of blowing agents are pentane, iso-pentane, butane, propane, and mixtures thereof, the most common being (iso-)pentane.

In addition to styrene, other olefinically unsaturated monomers can be present, resulting in an expandable polystyrene copolymer. The term “expandable polystyrene” or “EPS” in this specification includes expandable polystyrene homopolymer and expandable polystyrene copolymers.

Expandable polystyrene is generally used to prepare polystyrene foam. Such foam can be obtained from EPS in three steps: prefoaming, intermediate storage, and final foaming (or moulding). During prefoaming, the particles are heated and the polystyrene is thereby softened, the blowing agent in the polystyrene evaporates to form rapidly growing bubbles until either the heat supply is shut off or the expandability is exhausted. The bead diameter may increase about threefold and the bead volume (bulk volume) about thirtyfold.

Intermediate storage is required prior to final foaming into blocks, boards, or moulded parts to allow air to diffuse into the individual cells. Air is needed in subsequent moulding: it acts as a supplementary blowing agent and also enables the soft cellular structure to withstand the external atmospheric pressure when the finished part is removed from the mould.

Final foaming is usually fully automated: perforated moulds are completely filled with prefoamed beads and exposed to steam. The beads expand to fill the residual voids and are fused together. Some of the water condensed in the foam then evaporates and internal cooling reduces the pressure of the foamed plastic more rapidly, so that the parts can be quickly removed from the mould. Expandable polystyrene foams have many applications, including thermal insulation in, e.g., the building industry. For such applications fire resistance of the foams is often required. For this reason, it is generally desired for the polystyrene to also contain flame retardants. In EPS, halogenated, in particular brominated flame retardants are commonly used. Unfortunately, however, the presence of brominated flame retardants during styrene polymerization has a negative effect on the molecular weight of the polystyrene.

The objective of the present invention is to provide a process for the polymerization of styrene in the presence of a brominated flame retardant wherein the effect of the flame retardant on the molecular weight is counteracted. The present invention therefore enables the polymerization of styrene in the presence of a brominated flame retardant to produce polystyrene with at least the same molecular weight as obtained in the absence of flame retardant.

The present invention relates to a process for the suspension polymerization of styrene monomer to produce polystyrene in the presence of a brominated flame retardant. According to the process, a polymerization suspension comprising styrene monomer is heated to a temperature of at least 60° C. Subsequently, an initiator is dosed to this heated polymerization suspension during the polymerization reaction over a period of more than 90 minutes to less than 5 hours, in a continuous manner or intermittently in at least 2 portions, said period starting before a monomer conversion of 65% is reached and said initiator having a half-life at the temperature at which it is dosed of not more than 60 minutes. A brominated flame retardant is present in the polymerization suspension during the polymerization reaction.

It is noted that WO 2004/089999 discloses a process for the polymerization of styrene by dosing an initiator continuously or intermittently. However, dosing over a period of more than 90 minutes in the presence of a brominated flame retardant is neither disclosed nor suggested in this document.

### Monomers

The process according to the present invention involves the polymerization of styrene monomer in aqueous suspension.

In a preferred embodiment, styrene is the sole monomer that is present in the suspension, resulting in polystyrene homopolymer.

In another embodiment, additional co-monomers are present, resulting in a styrene copolymer. In this embodiment it is preferred that styrene is present in the aqueous suspension in an amount of at least 50 wt %, more preferably at least 80 wt %, based on the total weight of monomers. Co-monomers that can be used are of the conventional type and are preferably selected from the group consisting of divinyl benzene, vinyl acetate, ethylene, propylene, acrylonitrile, butadiene, (meth)acrylates, and ethylenically unsaturated polymers, such as polybutadiene and styrene butadiene rubber. Although it is less preferred, also vinylidene chloride can be present as co-monomer.

### Flame Retardants

Suitable brominated flame retardants for use in the process according to the present invention are hexabromocyclododecane (HBCD), pentabromobenzyl-bromide, tetrabromobisphenyl A bis(allylether), tetrabromobisphenyl A bis(2,3-dibromopropyl ether), dibromohexahydrophthalimide, N-methyl-dibromohexahydrophthalimide, N,N 2,3-dibromopropyl-4,5-dibromohexahydrophthalimide, bis(2,3-dibromopropyl)tetrabromophthalate, tris(2,3-dibromoisopropyl)-isocyanurate, tribromophenyl allyl ether, and brominated styrene (co)polymers. Examples of preferred brominated flame retardants are pentabromo-benzylbromide, tetrabromobisphenyl A bis(allylether), tris(2,3-dibromoisopropyl)-isocyanurate, and brominated styrene (co)polymers.

Flame retardant synergists may also be present. Examples of such synergists are dicumyl peroxide, di-(t-butylperoxyisopropyl)benzene, 2,3-dimethyl-2,3-diphenylbutane, 3,4-dimethyl-3,4-diphenylhexane, and poly(1,4-diisopropyl benzene). Commercially available synergists can be obtained under trade names such as Perkadox® BC and Perkadox® 30.

The polymerization suspension preferably comprises 0.3-6 wt %, more preferably 0.4-3 wt %, and most preferably 0.5-1.5 wt % of brominated flame retardant, based on the weight of styrene. The brominated flame retardant is preferably pre-charged to the polymerization suspension, before heating the suspension to the desired temperature. Alternatively, it may be dosed to the reaction mixture during the polymerization reaction as a solution in styrene.

### Dosing of Initiator During the Polymerization Reaction

In the process according to the present invention, an initiator is dosed to the polymerization suspension after it has been heated to a temperature of at least 60° C. Preferably, the polymerization suspension has been heated to at least 75° C., and more preferably at least 80° C. before dosing the initiator.

The initiator is dosed to the heated polymerization reaction over a period of more than 90 minutes, preferably more than 120 minutes to less than 5 hours, preferably less than 4 hours in a continuous manner or intermittently in at least 2, preferably at least 4, more preferably at least 10, and most preferably at least 20 portions. The time intervals between the portions may be the same or different. If intermittent dosing is applied, the last portion must be added more than 90 and preferably more than 120 minutes after the first portion. If many portions are added at short intervals, continuous dosing is approached.

Continuous dosing, which is the preferred manner of dosing, may be performed at constant or variable rate. The addition of initiator at variable rate is beneficial for using the cooling capacity of the polymerization reaction in the most optimal way and to reduce the risk of a so-called “run away” during the polymerization reaction. The rate at which initiator is continuously dosed is preferably in the range 1-100 meq/kg styrene/hour, more preferably 2-50 meq/kg styrene/hour, and most preferably 5-25 meq/kg styrene/hour; wherein meq refers to milli-equivalent and 1 equivalent is defined as 1 mole of peroxide or azo groups.

The dosing period does not start before the temperature of the polymerization suspension has reached 60° C., but does start before the monomer conversion has reached a level of 65%. Preferably, dosing of initiator starts before a conversion level of 60%, more preferably 40%, even more preferably 20%, even more preferably 10% is reached. Most preferably, initiator dosing starts at 0% conversion. This means that the first portion of the initiator is added after reaching the indicated temperature but below the indicated conversion level and that dosing of initiator subsequently continues over a period of more than 90 minutes.

The initiator is dosed to the aqueous suspension during the polymerization reaction, i.e. when polymerization proceeds and monomers actually react.

During the polymerization reaction, the temperature may be kept constant during a certain period, and may be increased and kept constant again for another period. This may be repeated one or more times. Alternatively, the temperature may be increased gradually to a certain maximum temperature which is kept constant for a certain period. Combinations of (subsequent) periods with continuous polymerization temperature increases and constant polymerization temperatures are also possible.

Preferably, the temperature during the polymerization reaction is at most 160° C., more preferably at most 150° C., and most preferably at most 140° C. The temperature is at least 60° C., preferably at least 75° C., and most preferably at least 80° C.

A part of the total initiator amount used, that is: 10 wt % to less than 50 wt %, preferably less than 40 wt %, and most preferably less than 30 wt %, may be pre-charged to the reaction mixture, prior to reaching a temperature of at least 60° C. When the reaction mixture is formulated at or near the temperature that is desired for the polymerization reaction to proceed, which is called the warm-start process, it is not required to pre-charge a certain amount of initiator. However, also in this warm-start process it may be beneficial to at once add up to 20 wt %, preferably up to 10 wt % of initiator, based on the combined weight of the monomers, to the reaction mixture prior to reaching a temperature of 60° C.

The total amount of initiator to be used in the process according to the invention is within the range conventionally used in polymerization processes. Typically, it is preferred to use at least 0.01 wt %, more preferably at least 0.05 wt %, and most preferably at least 0.1 wt %, and preferably at most 5 wt %, more preferably at most 3 wt %, and most preferably at most 2 wt %, based on the weight of the monomers to be polymerized.

Dosing to the reactor is typically effected by dosing the initiator as such (neat) or as a mixture or solution with one or more solvents, in the form of a solution, emulsion, or suspension. Suitable solvents are preferably selected from the group consisting of water, conventional organic solvents, monomers (such as styrene), blowing agents (such as pentane, isopentane, and the like), and mixtures thereof. Mixtures with monomer may not be preferred for safety or quality control reasons. Preferably, dispersions of the initiator, more preferably aqueous dispersions, are used. Most preferably, a suspension of the initiator in water is used, such as a 40 wt % dibenzoyl peroxide suspension in water. Said suspension can be obtained commercially from Akzo Nobel Polymer Chemicals under the trade name Perkadox® L W-40. If a dispersion of the initiator is dosed, the dispersion can be a dispersion of the initiator as such or a dispersion of a solution of said initiator. Preferably, the dispersion is an aqueous dispersion. Preferably, dilute initiator solutions or dispersions are used that ensure rapid mixing of the initiator and the polymerization mixture, which leads to a more efficient use of the initiator. Therefore, it is preferred to use solutions, emulsions, or suspensions of the initiator having an initiator concentration of at least 1, more preferably at least 5, and most preferably at least 10 wt %, up to at most 70, more preferably at most 60 wt %.

Initiators suitable for dosing to the aqueous suspension during the process according to the present invention are initiators that at the temperature at which they are dosed have a half-life, as measured in monochlorobenzene, of 60 minutes or less, preferably 50 minutes or less, even more preferably 30 minutes or less, and most preferably 15 minutes or less. At the same time, this half-life is preferably more than 0.5 minutes, more preferably more than 1 minute, even more preferably more than 2.5 minutes, and most preferably more than 5 minutes. The half-life of the initiators is determined by differential scanning calorimetry-thermal activity monitoring (DSC-TAM) of a dilute solution of the initiator in monochlorobenzene, as is known in the art. Half-life data determined in this way are listed in the Akzo Nobel brochure “Initiators for high polymers” with code 2161, June 2006.

It is noted that the word initiator is used here in the classical sense to denominate those compounds that generate free radicals, which, in turn, initiate the polymerization reaction. Hence, when certain thermally labile compounds are used for the purpose of (wholly or partially) surviving the polymerization conditions, e.g. such that they are present in the final polymer as a flame retardant synergist, the part that does not decompose is not to be seen as an initiator in accordance with the present invention.

Examples of suitable classes of initiators for dosing to the aqueous suspension during the process according to the invention are peroxydicarbonates, peroxycarbonates, peroxyesters, peroxyketals, diacylperoxides, dialkylperoxides, azo-initiators, ketone peroxides, and mixtures thereof. These initiators may have one or more peroxy and/or azo moieties per molecule. Optionally, these initiators are further functionalized with one or more functional groups, such as amide, chloride, phosphate, ester, ether and/or alcohol groups. Preferred initiators are substituted or unsubstituted dibenzoyl peroxides, 1,1-di(tert-butylperoxy)-3,3,5-trimethylcyclohexane, 2,2-di(tert-butyl peroxy)butane, 1,1-di(tert-butylperoxy)cyclohexane, dicetylperoxydicarbonate, dimyristylperoxydicarbonate, 1,1,3,3-tetramethylbutyl peroxypivalate, tert-butyl peroxyneodecanoate, tert-amyl peroxypivalate, tert-butyl peroxypivalate, di(3,5,5-trimethylhexanoyl)peroxide, dilauroyl peroxide, didecanoyl peroxide, 2,2′-azobis(isobutyronitrile), 2,2′-azobis(2-methylbutyronitrile), 2,5-dimethyl-2,5-di(2-ethylhexanoylperoxy)hexane, 1,1,3,3-tetramethylbutyl peroxy-2-ethyl hexanoate, tert-amylperoxy-2-ethylhexanoate, tert-butylperoxy-2-ethylhexanoate, tert-butyl peroxydiethylacetate, tert-butylperoxyisobutyrate, and combinations of one or more of these initiators. Most preferred are dibenzoyl peroxide, dicetylperoxydicarbonate, tert-butylperoxy-2-ethylhexanoate, and 2,2′-azobis(isobutyronitrile).

As in conventional (expandable) polystyrene production processes, the amount of residual monomer content in the polymer product can be reduced in the usual manner; preferably by adding an additional initiator which decomposes at a relatively high temperature, typically in the range 110-170° C. This additional initiator, also called second stage initiator, may be added at the start of or during the polymerization process, as such or dissolved in a solvent, for instance the blowing agent. Examples of suitable additional initiators are tert-butylperoxybenzoate, tert-butyl peroxy-2-ethylhexyl carbonate, dicumylperoxide, and tert-amyl peroxy-2-ethylhexyl carbonate.

### Blowing Agent

In order to make polystyrene expandable, a blowing agent has to be introduced. The blowing agent can be added to the aqueous suspension in the process of the present invention or can be added at a later stage, after the polystyrene has been prepared, by impregnation of the produced polystyrene with said blowing agent, or by extrusion of the produced polystyrene in the presence of blowing agent. The blowing agent can be added to the aqueous suspension in the process of the present invention or be added afterwards. Preferably, part or all of the blowing agent is introduced into the aqueous suspension when the degree of polymerization of the monomer is less than 90%, preferably less than 80%, and most preferably less than 70%. A suitable process was found to be one where the blowing agent was dosed or added within one hour of the start of the polymerization. The blowing agent can be added as such, or in admixture with the optional additional initiator mentioned above.

Suitable blowing agents are freons, linear or branched saturated hydrocarbons and cyclic saturated hydrocarbons, preferably C₃₋₇ hydrocarbons, in particular C₄₋₆ hydrocarbons, such as n-butane, isobutane, n-pentane, isopentane, n-hexane or isohexane, carbon dioxide, and mixtures of two or more of these compounds. The most preferred blowing agents are pentane and isopentane.

The blowing agent is preferably used in the process of the present invention in such an amount that the resulting EPS comprises, per 100 parts by weight of styrene (co)polymer, from 2 to 20 parts, preferably from 2 to 15 parts, and in particular from 2 to 10 parts by weight of blowing agent.

### Carbon Black

In order to improve the insulation value of the resulting polystyrene, carbon particulates (e.g. carbon black) can be added to the polymerization suspension.

Examples of particulate carbon that can be used in the process of the present invention include carbon black, graphite, and activated carbon. Examples of types of carbon black are oil furnace black (petroleum black), gas furnace black, acetylene black, lamp black, flame black (smoke black), channel black (carbon black obtained by small-flame combustion), thermal black, and electrically conductive carbon black. Electrically conductive carbon black differs from the other carbon blacks in particular in an extremely high specific surface area. The carbon particulates preferably have an average particle size of 0.1-300 microns, more preferably 0.5-150 microns, and most preferably 1-100 microns.

Examples of commercially available carbon blacks are N550 ex-Cabot and Lampblack FW101 ex Degussa.

Examples of commercially available electrically conductive carbon blacks are Ketjenblack® EC-300JD and Ketjenblack® EC-600JD (ex Akzo Nobel) and Ensaco® and Super P® conductive carbon black (ex Timcal).

Examples of commercially available graphites are Graphit UFZ 99.5, Graphit UF2 96/96, expandable graphite ES200 A5 (all ex Graphit Kropfmühl AG), expandable graphite type 2151 (ex Bramwell Graphite AG), and Timtex® graphite (ex Timcal).

The particulate carbon may be added to the styrene and homogeneously dispersed, it may be added to the polymerization suspension before the polymerization process, or it may be added to the polymerization suspension during the polymerization reaction. The particulate carbon can be added as powder, as dispersion or slurry in styrene, as dispersion or slurry in water, in admixture with both styrene and water, or as polystyrene granules in which the carbon has been incorporated by, e.g., a melt-mixing process.

The particulate carbon is preferably added to the polymerization suspension in an amount of 0.1-25 wt %, more preferably 0.5-8 wt %, based on the weight of monomers.

### Other Ingredients

Various other ingredients may be added to the polymerization suspension, such as suspension stabilizers (e.g. tricalcium phosphate, magnesium pyrophosphate, sodium dodecylbenzene sulphonate, persulphate, bisulphite, polyvinylalcohol, polyvinylpyrrolidone), buffer salt, nucleating agent (e.g. polyethylene wax), surfactants, chain transfer agents, protective colloids, anti-fouling agents, pH-buffers, etc. The combined weight of these additives preferably is at most 20 wt %, based on the combined weight of all monomers.

### The Resulting Polystyrene

The polystyrene resulting from the process according to the present invention preferably has a weight-average molecular mass, Mw, in a range of from 140,000 to 300,000 daltons, more preferably from 160,000 to 280,000 daltons, and most preferably from 180,000 to 260,000 daltons.

The weight-average molecular mass is typically measured using conventional Gel

Permeation Chromatography (GPC) using polystyrene standards.

The molecular weight distribution of the styrene polymer, calculated by the ratio of Mw to the number-average molecular mass Mn of the polymer, preferably ranges from 1.5 to 4.0, more preferably from 1.7 to 3.5, and most preferably from 1.8 to 3.0.

The polystyrene resulting from the process according to the present invention preferably has a relatively low level of residual styrene monomer and, where appropriate, of residual comonomer(s). The residual monomer content is preferably not more than 5,000 mg/kg of monomer, preferably less than 2,000 mg/kg of monomer, more preferably less than 1,000 mg/kg of monomer.

The polystyrene resulting from the process of the present invention may be in the form of particles or, preferably, of expandable beads. By beads are meant, generally, spherical or substantially spherical particles, in particular spheroidal particles which may have a large diameter and a small diameter, with a ratio between the large diameter and the small diameter ranging in particular from 1.0 to 1.3, preferably from 1.0 to 1.2. The expandable particles or beads may have an average size ranging from 0.2 to 3 mm, preferably from 0.3 to 2 mm, in particular from 0.4 to 1.5 mm.

### Miscellaneous

It is noted that the process according to the present invention does not require the use of a pre-polymerization process or the addition of seed particles. However, if so desired, polymer particles, especially particles of an undesired particle size resulting from earlier polymerization batches, may be recycled. If used, the particles are preferably dissolved in the monomer before or during the heating of the polymerization suspension to the desired temperature. Preferred is an addition of 0.5-30, most preferably of 3-20 wt. % of polystyrene in styrene monomer.

Alternatively, styrene may be prepolymerized in a suspension polymerization process and the resulting beads are added to the polymerization suspension used in the process of the present invention.

### EXAMPLES

### Examples 1-7

### Conventional Polymerization

Into a 1-litre stainless steel reactor equipped with a baffle, a three-bladed impeller, a pressure transducer, and a nitrogen purge, were charged 1.25 g of tricalcium phosphate. Subsequently, 260 g of an aqueous solution containing 20 mg sodium benzene dodecyl sulphonate were added to the reactor and stirred for approximately 5 minutes. A solution of dibenzoyl peroxide (Perkadox® L-W75 ex AkzoNobel; 1.00 meq/100 g styrene), tert-butylperoxy 2-ethylhexyl carbonate (Trigonox® 117 ex Akzo Nobel; 0.46 meq/100 g total styrene), and optionally hexabromocyclododecane (HBCD) and dicumyl peroxide (Perkadox® BC ex Akzo Nobel; 0.2% based on total weight of styrene) was made in 250 g styrene and charged to the reactor. Trigonox® 117 served as a second stage initiator, generally causing initiation at higher temperatures, and Perkadox® BC served as a flame retardant synergist and was only added in combination with HBCD.

The temperature was raised to 90° C. at a rate of 1.56° C./min and kept at 90° C. for 4.25 hours. Subsequently, the temperature was increased to 130° C. at a rate of 0.67° C./min, at which temperature the reactor was maintained for 3 hours. About 15 minutes before the temperature increase to 130° C., 20 g pentane were added from a vessel by pressurizing the reactor with nitrogen (5 bar).

After being cooled to room temperature (overnight), the reaction mixture was acidified with HCl (10%) to pH 1.5 and stirred for about 1 hour. The product was filtered and the EPS beads obtained were washed with water to pH>6 and with an aqueous solution of 25 ppm Armostat 400 (antistatic), respectively. Finally, the EPS was dried at room temperature for about 24 hours.

### Continuous Initiator Dosing (CiD) Polymerization

The same equipment and ingredients were used as described above, except for the following. The reaction mixture with all ingredients but without initiators was heated to 110° C. When the temperature reached 85° C., the dosing of the dibenzoyl peroxide (Perkadox® L-W40) was started. The peroxide—1 meq dibenzoyl peroxide/100 g styrene suspension—was dosed continuously to the reactor during a certain time period (dosing time) using a peristaltic pump. Then, pentane and the second stage initiator, Trigonox® 117, were added, the reaction mixture was heated to 130° C., and the procedure was finished as described above.

The weight average molecular weight of the obtained polystyrene—size exclusion chromatography (SEC)—using different dosing times is listed in Table 1.

This table shows that the presence of flame retardant reduces the molecular weight of the produced polystyrene, but that the dosing of initiator, in contrast to pre-charging, gives less reduction of molecular weight. Further, the molecular weight reduction decreases with the length of the dosing time.

TABLE 1

| | | Flame | Dosing time | Mw |
|---|---|---|---|---|
| Example | Procedure | retardant^{a} | (min) | (kg/mol) |
| 1 (Comp.) | Conventional | None | Precharged | 232 |
| 2 (Comp.) | Conventional | HBCD | Precharged | 190 |
| 3 | CiD | None | 174 | 239 |
| 4 | CiD | HBCD | 166 | 210 |
| 5 | CiD | HBCD | 180 | 225 |
| 6 | CiD | HBCD | 205 | 237 |
| 7 | CiD | HBCD | 215 | 265 |

^{a}HBCD: 0.56% (0.42% Br) w/w on styrene.

### Example 8

### Comparative

A 1-liter stirred reactor was charged with 1.125 g tricalcium phosphate, 10 g of a 0.2 wt % sodium dodecylbenzenesulphonate solution (Nacconol 90G), and 365 g water. This mixture was stirred for 5 minutes at 500 rpm. Next, a solution of 0.550 g dicumyl peroxide (Perkadox® BC-FF) and 1.663 g hexabromocyclododecane (HBCD) in 228.26 g styrene was added to the reactor and the temperature was raised to 90° C. in 45 minutes. When the temperature reached 90° C., 2.5 g graphite (Graphit Kropfmühl AG) and a solution of 1.097 g dibenzoyl peroxide (Perkadox L-W75) in 21.74 g styrene were added and the temperature was kept at 90° C. for 6 hours. Finally the temperature was decreased to 25° C. in 45 minutes.

### Example 9

The procedure was similar to example 8, exept for the manner of adding dibenzoyl peroxide (Perkadox® L-W75). In the present example, dibenzoyl peroxide (1.097 g, dissolved in 21.74 g styrene) was added to the reaction mixture in 12 portions at regular time intervals during 2 hours. This addition was started when the temperature reached 90° C. After adding the complete amount of initiator, the temperature was kept at 90° C. for another 4 hours, followed by cooling the reactor down to 25° C. in 45 minutes.

The styrene conversion in Examples 8 and 9 was determined by gravimetrical measurement of the solids content of the organic phase of the reaction mixture. Molecular weights were determined by SEC, as described above.

| | | Conversion | Mn | Mw | |
|---|---|---|---|---|---|
| Example | Method | (%) | (kg/mol) | (kg/mol) | PDI |
| 8 (Comp) | Conventional | 25.1 | 134 | 362 | 2.7 |
| 9 | CiD | 22.2 | 161 | 408 | 2.5 |

This table shows that, also in the presence of particulate carbon, dosing of initiator, in contrast to precharging, results in higher molecular weights.

1. A process for the suspension polymerization of styrene monomer to produce polystyrene comprising the steps of:
a) heating a polymerization suspension comprising the styrene monomer to a temperature of at least 60° C.,
b) dosing an initiator to said heated polymerization suspension during the polymerization reaction over a period of more than 90 minutes to less than 5 hours, in a continuous manner or intermittently in at least 2 portions, said period starting at a monomer conversion of 65% of less and said initiator having a half-life at the temperature at which it is dosed of not more than 60 minutes,
wherein a brominated flame retardant is present in the polymerization suspension during the polymerization reaction.

2. The process according to claim 1 wherein the initiator is dosed to the heated polymerization suspension over a period of 2-4 hours.

3. The process according to claim 1 wherein the initiator is dosed to the heated polymerization suspension in a continuous manner.

4. The process according to claim 1 wherein the initiator is dosed to the heated polymerization suspension intermittently in at least 20 portions.

5. The process according to claim 1 wherein said period starts at 0% monomer conversion.

6. The process according to claim 1 wherein the brominated flame retardant is selected from the group consisting of hexabromocyclododecane (HBCD), pentabromobenzylbromide, tetrabromo [symbol] bisphenyl A bis(allylether), tetrabromobisphenyl A bis(2,3-dibromopropyl ether), dibromohexahydrophthalimide, N-methyl-dibromohexahydro [symbol] phthalimide, N,N 2,3-dibromopropyl-4,5-dibromohexahydrophthalimide, bis(2,3-dibromopropyl)tetrabromophthalate, tris(2,3-dibromoisopropyl) [symbol] isocyanurate, tribromophenyl allyl ether, and brominated styrene (co)polymers.

7. The process according to claim 1 wherein the polymerization suspension comprises particulate carbon.

8. The process according to claim 1 wherein a blowing agent is added to the polymerization suspension.

9. The process according to claim 1 wherein the initiator is selected from the group consisting of peroxydicarbonates, peroxycarbonates, peroxyesters, peroxyketals, diacylperoxides, dialkyl-peroxides, ketone peroxides, and azo-initiators.

10. The process according to claim 9 wherein the initiator is selected from the group consisting of dibenzoyl peroxide, dicetylperoxydicarbonate, ter-butyl-peroxy-2-ethylhexanoate, 2,2′-azobis(isobutyronitrile), and mixtures thereof.

11. The process according to claim 1 wherein the polymerization reaction is performed at a temperature in the range 60-160° C.

12. The process according to claim 1 wherein the initiator is dosed in the form of an aqueous dispersion.

13. The process according to claim 2 wherein the initiator is dosed to the heated polymerization suspension in a continuous manner.

14. The process according to claim 2 wherein the initiator is dosed to the heated polymerization suspension intermittently in at least 20 portions.

15. The process according to claim 2 wherein said period starts at 0% monomer conversion.

16. The process according to claim 2 wherein the brominated flame retardant is selected from the group consisting of hexabromocyclododecane (HBCD), pentabromobenzylbromide, tetrabromo [symbol] bisphenyl A bis(allylether), tetrabromobisphenyl A bis(2,3-dibromopropyl ether), dibromohexahydrophthalimide, N-methyl-dibromohexahydro [symbol] phthalimide, N,N 2,3-dibromopropyl-4,5-dibromohexahydrophthalimide, bis(2,3-dibromopropyl)tetrabromophthalate, tris(2,3-dibromoisopropyl) [symbol] isocyanurate, tribromophenyl allyl ether, and brominated styrene (co)polymers.

17. The process according to claim 2 wherein the polymerization suspension comprises particulate carbon.

18. The process according to claim 2 wherein a blowing agent is added to the polymerization suspension.

19. The process according to claim 2 wherein the initiator is selected from the group consisting of peroxydicarbonates, peroxycarbonates, peroxyesters, peroxyketals, diacylperoxides, dialkyl-peroxides, ketone peroxides, and azo-initiators.

20. The process according to claim 2 wherein the polymerization reaction is performed at a temperature in the range 60-160° C.
